(19) United States
(12) Patent Application Publication
(10) Pub. No.: US 2007/0091750 A1
(43) Pub. Date: Apr. 26, 2007

(54) Optical disk device

(75) Inventor: Kozo Wada, Osaka (JP)

Correspondence Address: PILLSBURY WINTHROP SHAW PITTMAN, LLP, P.O. BOX 10500, MCLEAN, VA, 22102, US

(73) Assignee: FUNAI ELECTRIC CO., LTD., Osaka (JP)

(21) Appl. No.: 11/583,102

(22) Filed: Oct. 19, 2006

(30) Foreign Application Priority Data
Oct. 20, 2005 (JP) 2005-305508

(51) Int. Cl. G11B 19/00

(52) U.S. Cl. 369/47.47

(57) ABSTRACT

An optical disk device includes an optical pickup which irradiates laser light upon an optical disk including CAPAs and detects the reflected light, and a spindle motor which rotates the optical disk. Furthermore, the optical disk device includes a CAPA signal generation means which, from the reflected light detected by the optical pickup, generates a CAPA signal, which is a signal including the CAPA, and a rotation control means which acquires, from the CAPA signal generated by the CAPA signal generation means, interval information which indicates the interval at which the CAPA is detected, and address information for the sectors upon the optical disk. And, based upon the interval information and the address information, the rotation control means drives the spindle motor so that the rotational speed or the linear speed of the optical disk becomes equal to a target value.

### CROSS REFERENCE

This Nonprovisional application claims priority under 35 U.S.C. §119(a) on Patent Application No. 2005-305508 filed in Japan on Oct. 20, 2005, the entire contents of which are hereby incorporated by reference.

### BACKGROUND OF THE INVENTION

The present invention relates to an optical disk device which performs reading of data recorded upon an optical disk such as a DVD-RAM or the like having CAPA (Complementary Allocated Pit Addressing), in which sector address information is recorded at predetermined intervals by pre-formatting the optical disk.

In the past, optical disk devices which perform reading of data recorded upon optical disks such as DVD-RAM and the like have become widespread.

As is per se well known, with such a prior art optical disk device, laser light of a reading power is irradiated upon the optical disk, and thereby the data recorded upon the optical disk is read.

And, with a prior art type optical disk device, during this reading, tracking servo control is performed in which the position of irradiation of the laser light is aligned to the center of the track upon the optical disk, and focus servo control is performed in which the focal position of the laser light is aligned to the recording surface of the optical disk. Moreover, with a prior art type optical disk device, spindle servo control is also performed, in which the rotation of the optical disk is controlled so as to bring the rotational speed or the linear speed of the optical disk to be equal to a target value.

A control system for such spindle servo control in a prior art optical disk device, generally, has comprised a spindle motor which rotates the optical disk, an FG sensor fitted to this spindle motor which detects the rotational speed of the spindle motor, and an FG servo circuit which performs rotation control of the spindle motor based upon the output signal of the FG sensor. And the control system for spindle servo control performs spindle servo control by employing these structures.

On the other hand, an optical disk device which performs spindle servo control with a CAV method using an FG sensor has been proposed in Japanese Laid-Open Patent Publication H10-289521.

However, from the opposite point of view, in order to perform the above described spindle servo control, the above described FG sensor and FG servo circuit constitute a structure which cannot be omitted. This means that the problems are entailed that material and components for the above described FG sensor and FG servo circuit must be provided, and that the manufacturing cost and the complication of the manufacturing process are increased.

Furthermore, in the above cited Japanese Laid-Open Patent Publication H10-289521 as well, with regard to performing spindle servo control using an FG sensor, the situation is the same as with the prior art optical disk device described above. Due to this, the same problems occur.

A feature of the present invention is to provide an optical disk device which performs spindle servo control with a low cost structure, without using any FG sensor or FG servo circuit.

### SUMMARY OF THE INVENTION

The optical disk device according to the present invention includes an optical pickup which irradiates laser light upon an optical disk including CAPAs, in which address information for sectors is recorded at predetermined intervals, by pre-formatting the optical disk, and detects the reflected light, and a spindle motor which rotates a motor according to a voltage which is applied, and rotates the optical disk.

Moreover, this optical disk device includes a CAPA signal generation means which, from the reflected light detected by the optical pickup, generates a CAPA signal, which is a signal including the CAPA, and a rotation control means which acquires, from the CAPA signal generated by the CAPA signal generation means, interval information which indicates the interval at which the CAPA is detected, and address information for the sectors upon the optical disk. With this structure, the intervals at which the CAPA is detected are equal intervals.

Moreover, based upon the interval information and the address information, the rotation control means performs rotation control of the spindle motor by a predetermined rotation control method, and sets a target value for the rotational speed or the linear speed of the optical disk.

With this structure, the rotation control means calculates the current rotational speed or linear speed of the spindle motor from the interval information. Furthermore, the rotational control means calculates the position of the sector which is currently being illuminated with the laser light, from the address information.

And, based upon the current rotational speed or linear speed of the spindle motor and the position of the sector which is currently being illuminated with the laser light, the rotation control means drives the spindle motor, so as to bring the rotational speed or the linear speed of the optical disk to that target value. This target value is a different value according to the rotation control method which is adopted, such as the ZCLV method, the CLV method, the CAV method, or the like.

### BRIEF DESCRIPTION OF THE DRAWINGS

FIG. 1 is a block diagram showing the structure of the main portion of an optical disk device according to an embodiment of the present invention;

FIG. 2 is a conceptual figure showing the situation for the case in which an optical disk 100 is rotated by the CLV method;

FIG. 3 is a conceptual figure showing the situation for the case in which an optical disk 100 is rotated by the CAV method; and

FIG. 4 is a conceptual figure showing the format of a typical sector upon an optical disk 100.

### DETAILED DESCRIPTION OF THE INVENTION

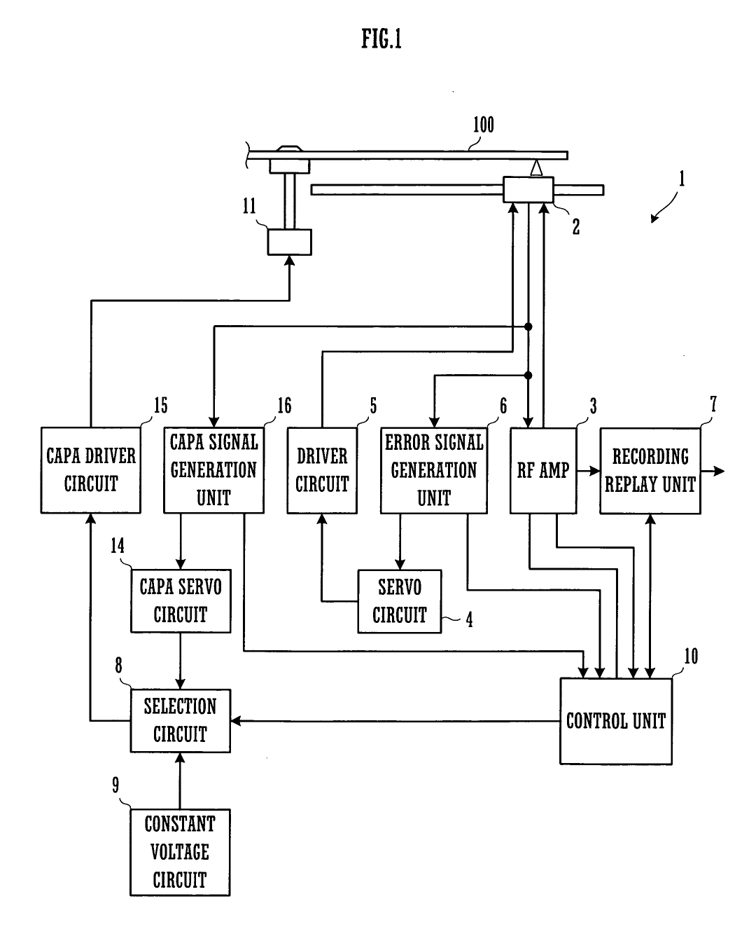

FIG. 1 is a block diagram showing the structure of the main portion of an optical disk device which is an embodiment of the present invention. This optical disk device 1 comprises a control unit 10 which controls the various parts of the optical disk device 1, an optical pickup 2 which irradiates laser light upon an optical disk 100 and detects the light reflected therefrom, an RF amp 3 which generates an RF signal based upon this reflected light, an error signal generation unit 6 which generates an error signal from this reflected light, a servo circuit 4 which generates a drive signal based upon this error signal, a driver circuit 5 which performs servo control based upon this drive signal, and a recording replay unit 7 which generates a reply signal from the RF signal and outputs this relay signal to externally.

Moreover, the optical disk device 1 comprises a spindle motor 11 which rotates the optical disk 100, a CAPA signal generation unit 16 which generates a CAPA signal from the above described reflected light, a CAPA servo circuit 14 which generates a CAPA drive signal based upon this CAPA signal, a constant voltage circuit 9 which generates a voltage which has a fixed value, a selection circuit 8 which changes over the input to the CAPA driver circuit 15 upon a command from the control unit 10, and a CAPA driver circuit 15 which drives the spindle motor 11 based upon an electric signal which is inputted.

This optical disk device 1 is a so called DVD player. Furthermore, the optical disk 100 is a so called DVD-RAM. The control unit 10 may consist of, for example, a microcomputer, and it houses internally a ROM (not shown in the figure) for storing its main control program.

The optical pickup 2 comprises a laser diode (LD), a collimator lens, a beam splitter, an objective lens, a photodetector, a thread motor, an actuator, and the like, none of which are shown in the figures.

This optical pickup 2 is mounted upon a shaft so as to be shiftable along the radial direction of the optical disk 100, just as in the case of a prior art type optical disk device. The thread motor shifts the optical pickup 2 in the radial direction of the optical disk 100.

The LD is a light source for outputting laser light. The photodetector consists of a plurality of light receiving elements, and detects the light reflected from the optical disk 100. This photodetector may, for example, be divided into four almost equal light receiving regions, thus consisting of four light receiving regions.

The objective lens adjusts the irradiation position of the laser light upon the optical disk 100. Furthermore, the actuator shifts the objective lens along the direction towards and away from the optical disk 100, and in the radial direction of the optical disk 100.

Now, the operation of this device during replay will be explained in the following.

The optical pickup 2 irradiates laser light of reading power upon the optical disk 100, and detects the light which is reflected from the optical disk 100 with the photodetector. By doing this, the optical disk device 1 optically reads out the data which is recorded upon the optical disk 100.

The RF amp 3 generates an RF signal based upon the reflected light from the optical disk 100, which has been detected by the plurality of light reflecting elements which make up the photodetector provided to the optical pickup 2. And the RF amp 3 amplifies this RF signal and outputs it to the recording replay unit 7. This RF signal is a read signal for the data which is recorded upon the optical disk 100.

The recording replay unit 7 processes this RF signal and extracts the video and audio therefrom. Here, the data which is extracted is encoded, for example, in MPEG. And the recording replay unit 7 decodes this data and generates a replay signal, which it outputs externally to the optical disk device 1. For example, a liquid crystal monitor and a speaker may be connected to the optical disk device 1.

In the following, the focus servo control and the tracking servo control will be explained.

The error signal generation unit 6 generates a focus error signal (hereinafter termed the “FE signal”) based upon the light which is reflected from the optical disk 100 and detected by the plurality of light receiving elements which make up the photodetector provided to the optical pickup 2, and outputs this FE signal to the servo circuit 4.

Furthermore, the error signal generation unit 6 generates a tracking error signal (hereinafter termed the “TE signal”) based upon the light which is reflected from the optical disk 100 and detected by the plurality of light receiving elements which make up the photodetector provided to the optical pickup 2, and outputs this TE signal to the servo circuit 4.

Based upon the FE signal and the TE signal which are outputted by the error signal generation unit 6, the servo circuit 4 generates a focusing drive signal for bringing the value of the FE signal to zero (its reference level) and a tracking drive signal for bringing the value of the TE signal to zero (its reference level). And the servo circuit 4 outputs these drive signals to the driver circuit 5.

The driver circuit 5 supplies the focusing drive signal to an actuator, and shifts the objective lens of the optical pickup 2 along the optical axis direction with respect to the optical disk 100. By doing this, focus servo control is performed so as to focus the laser light upon the recording surface of the optical disk 100.

Furthermore, the driver circuit 5 supplies the tracking drive signal to an actuator, and shifts the objective lens of the optical pickup 2 along the radial direction of the optical disk 100. By doing this, tracking servo control is performed so as to irradiate the laser light upon the center of the track of the optical disk 100.

By performing the above described focus servo control and tracking servo control, along with it being possible to make the laser light follow along the desired track, the focal point of the laser light can be adjusted to be upon this track.

In the following, the rotation control method will be explained. This rotation control method may be the PCAV method, the ZCLV method, the ZCAV method, the CLV method, or the CAV method.

The CLV (Constant Linear Velocity) method is a method in which the linear speed is kept constant; in other words, the speed at which the data is read out is kept constant.

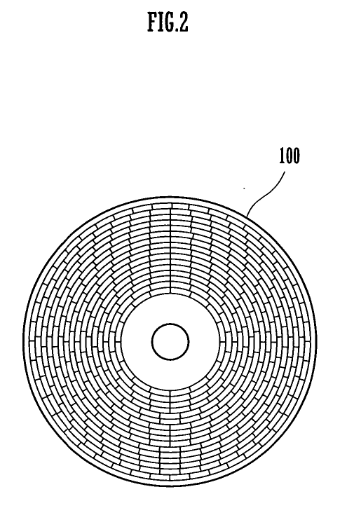

FIG. 2 is a conceptual figure showing the situation for the case in which the optical disk 100 is rotated by the CLV method. In this figure, it is shown that the length of each block on each track, which indicates the linear speed, is a constant linear speed value for all of the tracks. Since the amount of data is greater towards the radially outward direction of the optical disk 100, when reading out from the outer portion of the optical disk 100, the optical disk device 1 lowers the rotational speed of the optical disk 100. This method is generally employed for music CDs.

The CAV (Constant Angular Velocity) method is a method in which the angular velocity is kept constant; in other words, the rotational speed of the disk is kept constant.

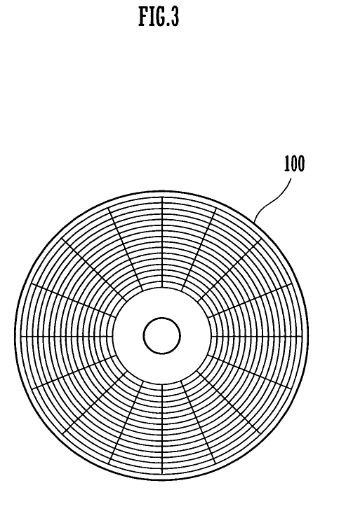

FIG. 3 is a conceptual figure showing the situation for the case in which an optical disk 100 is rotated by the CAV method. In this figure, it is shown that the length of each block on each track, which indicates the linear speed, becomes greater from the radially inner portion of the disk towards its radially outer portion. In the case of data which is different from that on a music CD (for example, text data), there is no requirement for performing reading at a constant speed, and, since the position of reading out is also random, keeping the rotational speed constant is an easier way of proceeding. The reading out of the data is slower for data at the radially inner portion of the disk, and faster for data at its radially outer portion.

The ZCLV (Zone CLV) method is a method in which the disk is divided into a certain number of regions (zones) from its inner periphery towards its outer periphery, and the rotational speed is kept constant within each of these regions. This ZCLV method exhibits the characteristics of both the CAV method and the CLV method, and, generally, it is used for a DVD-RAM or the like.

The ZCAV (Zone CAV) method is a method in which the disk is divided into a certain number of regions (zones) from its inner periphery towards its outer periphery, and the linear speed is kept constant within each of these regions. This ZCAV method exhibits the characteristics of both the CAV method and the CLV method, and, generally, it is used for a hard disk or the like.

And the PCAV (Partial CAV) method is a method in which, at the radially inner portion of the disk, the CAV method (in which the angular velocity is kept constant) is used, while, at the radially outer portion of the disk, the CLV method (in which the linear speed is kept constant) is used. This PCAV method is the method which is generally used with a high speed drive, and, with this method, although the performance at the radially inner portion of the disk is decreased by keeping the rotational speed down, the stability during high speed writing is enhanced.

Next, the structure of a DVD-RAM will be explained.

An optical disk 100 which is a so called DVD-RAM has a land track and a groove track. Data is recorded in both this land track and this groove track, which are divided into a plurality of sectors.

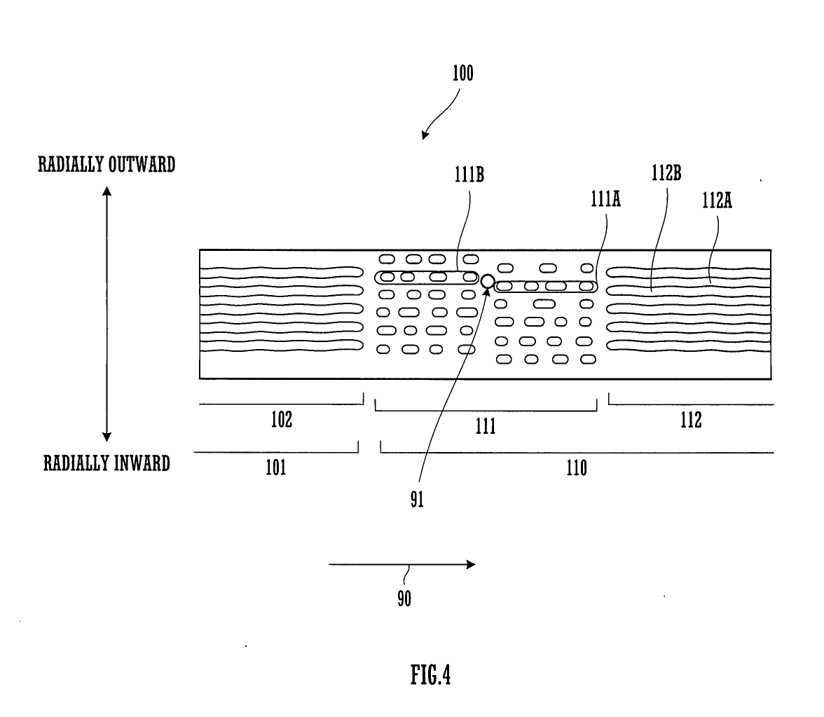

FIG. 4 is a conceptual figure showing the format of a typical sector upon an optical disk 100.

The laser light which is irradiated from the optical pickup 2 proceeds in the direction from the left to the right in FIG. 4, as shown by the arrow sign 90.

The current sector region 110 is defined as being the region in which the sector which is currently being irradiated with laser light is included. The current sector region 110 consists of a CAPA region 111 in which address information for the sector is recorded by pre-formatting, and a data region 112 in which the data is actually recorded. This CAPA region 111 includes regions 111A and 111B. And the data region 112 includes a land 112A and a groove 112B.

Furthermore, the previous sector region 101 is defined as being the region which includes the sector upon which the laser light was being irradiated directly before the current sector region 110. Naturally, this previous sector region 101 also includes a data region 102.

The sector upon which the laser light is currently being irradiated is shown by the spot 91 in FIG. 4, and this is a sector in which the land track is present. This sector consists of the CAPA region 111A or the CAPA region 111B in which the address information of this sector is recorded by pre-formatting and the land 112A in which the data is actually recorded. Of course, data is also recorded in the groove 112B, which consists of the sectors in the groove track. The physical address and the sector number upon the optical disk 100, or the position of the sector or the like, is recorded in the address information for the sector.

The CAPA region 111A or the CAPA region 111B are recorded as being displaced by half a track in the radial direction of the optical disk 100 with respect to the groove 112A or the land 112B.

The CAPA included in the CAPA region 111A or the CAPA region 111B is pre-formatted upon the optical disk 100 at predetermined intervals. This pre-formatting is, for example, emboss processing.

It should be understood that although, in this embodiment, it is supposed that the optical disk 100 is a DVD-RAM, this is not to be considered as being limitative of the present invention. The present invention is not particularly limited in its actual application, provided that the optical disk is one which has CAPA in which the sector address information is recorded as pre-formatted at predetermined intervals.

Next, returning to FIG. 1, the spindle servo control will be explained in order from the operation when an optical disk 100 has been mounted to the optical disk device 1.

When the optical disk 100 has been mounted to the optical disk device 1, by the selection circuit 8 being changed over, the input to the CAPA driver circuit 15 is supplied from the constant voltage circuit 9. This is done because, when the optical disk 100 is first mounted to the optical disk device 1, the focus of the laser light which is being irradiated from the optical pickup 2 is not set to match the surface of the optical disk 100, so that the CAPA on the optical disk 100 cannot be read.

Thus, the constant voltage circuit 9 generates a voltage of a constant value, and applies it to the spindle motor 11, via the selection circuit 8 and the CAPA driver circuit 15.

The spindle motor 11 rotates the motor according to the voltage which is supplied, and thereby the optical disk 100 is rotated.

After some little time, when the focus of the laser light which is being irradiated upon the optical disk 100 from the optical pickup 2 has become set to match its surface, the CAPA signal generation unit 16 becomes able to generate a CAPA signal based upon the reflected light. Here, a signal having a predetermined amplitude level is determined in advance as being a valid CAPA signal. And, along with the CAPA signal generation unit 16 outputting the CAPA signal which is being generated to the CAPA servo circuit 14, it outputs to the control unit 10 a control signal which conveys the information that the CAPA signal is being generated.

Here, as shown in FIG. 4, the CAPA region 111A or the CAPA region 111B is recorded as being displaced by half a track in the radial direction of the optical disk 100 with respect to the groove 112A or the land 112B. If the photodetector which is included in the optical pickup 2 consists of four light receiving regions as described above, then the signals which are generated from all of these light receiving regions are the RF signal. Moreover, in this case, the CAPA signal is a signal which is created from the differential between one semicircular light receiving region and another semicircular light receiving region.

Upon receipt of this control signal, the control unit 10 commands the selection circuit 8 to connect the input to the CAPA driver circuit 15 to the CAPA servo circuit 14. Upon receipt of this command, the selection circuit 8 changes over the input to the CAPA driver circuit 15 to the CAPA servo circuit 14.

It should be understood that it would also be acceptable to arrange for the CAPA servo circuit 14 to output the above described control signal to the control unit 10, at the stage at which it has acquired, from the CAPA signal which is inputted, information about the interval which is detected by the CAPA, and the address information for the sectors upon the optical disk 100.

The CAPA servo circuit 14 acquires, from the CAPA signal which is inputted, the interval information which indicates the interval detected by the CAPA, and the address information for the sectors upon the optical disk 100. Here, in order to acquire these from the CAPA signal, the CAPA servo circuit 14 performs waveform shaping or A/D conversion upon the CAPA signal, or elimination of the encoding thereof, or the like. Furthermore, the intervals which are detected by the CAPA are equal intervals. This interval information is, for example, the period which is detected by the CAPA.

And the CAPA servo circuit 14 calculates the current rotational speed of the spindle motor 11, or the current linear speed, based upon this interval information. Furthermore, the CAPA servo circuit 14 calculates the position of the sector which is currently being irradiated by the laser light, based upon the address information of the sector upon the optical disk 100.

And the CAPA servo circuit 14 generates a CAPA drive signal in order to bring the rotational speed of the optical disk 100, or its linear speed, to the target value, based upon the current rotational speed of the optical disk 100, or its linear speed, and upon the position of the sector which is currently being irradiated by the laser light. And the CAPA servo circuit 14 outputs this CAPA drive signal to the CAPA driver circuit 15.

The above described target value is different for the different rotation control methods, and is determined in advance as described below.

First, the case in which the rotation control method is the CLV method will be explained. In the case of the CLV method, it is necessary to perform reading by lowering the rotational speed of the optical disk 100 to a slower rotational speed when reading from the outer peripheral portion thereof, than when reading from the inner peripheral portion thereof. Due to this, in the case of this CLV method, the above described target value is set to a higher value of rotational speed when the position of the sector which is being irradiated by the laser light at the present time is towards the inner periphery of the optical disk 100. Conversely, when the position of this sector is towards the outer periphery of the optical disk 100, the above described target value is set to a lower rotational speed value. In other words, the above described target value is determined so that the linear speed is constant.

Next, the case in which the rotation control method is the CAV method will be explained. In the case of this CAV method, the angular velocity of the optical disk 100 is kept constant; in other words, the rotational speed thereof is kept constant. Due to this, in the case of this CAV method, the above described target value is kept at the same value of rotational speed, whether the position of the sector which is being irradiated by the laser light at the present time is towards the inner periphery of the optical disk 100, or is towards its outer periphery. In other words, the above described target value is determined so that the linear speed is slowest at the inner periphery of the optical disk 100, and becomes fastest at the outer periphery of the optical disk 100.

Next, the case in which the rotation control method currently being performed is the ZCLV method will be explained. In the case of this ZCLV method, the optical disk 100 is divided into a number of regions (zones) from its inner periphery towards its outer periphery. And, with this ZCLV method, the above described target value is set so that the rotational speed within a single one of these regions is constant, while the linear speed is constant between the regions.

Apart from the methods described above, for the PCAV method as well, the above described target value may be calculated in the same manner as in the ZCLV method, the ZCAV method, the CLV method, or the CAV method.

The CAPA driver circuit 15 drives the spindle motor 11 based upon the CAPA drive signal which is inputted via the selection circuit 8.

According to the above, it is possible to perform spindle servo control in this optical disk device 1 using a low cost structure, without using any FG sensor or FG servo circuit, using any of the PCAV rotation control method, the ZCLV rotation control method, the ZCAV rotation control method, the CLV rotation control method, the CAV rotation control method, or the like.

Here, the CAPA servo circuit 14, the CAPA driver circuit 15, and the control unit 10 correspond to the “rotation control means” of the Claims.

Finally, in the above described explanation of an embodiment of the present invention, all of the features are shown by way of example, and should not be considered as being limitative of the present invention. The scope of the present invention is not to be defined by any of the features of the embodiment described above, but only be the scope of the appended Claims. Moreover, equivalents to elements in the Claims, and variations within their legitimate and proper scope, are also to be considered as being included within the range of the present invention.

What is claimed is:

1. An optical disk device, comprising:
an optical pickup which irradiates laser light upon an optical disk including CAPAs, in which address information for sectors is recorded at predetermined intervals, by pre-formatting the optical disk, and detects the reflected light;
a spindle motor which rotates a motor according to a voltage which is applied, and rotates the optical disk;
a CAPA signal generation means which, from the reflected light detected by the optical pickup, generates a CAPA signal, which is a signal including the CAPA; and
a rotation control means which acquires, from the CAPA signal generated by the CAPA signal generation means, interval information which indicates the interval at which the CAPA is detected, and address information for the sectors upon the optical disk,
wherein, based upon the interval information and the address information, the rotation control means performs rotation control of the spindle motor by a predetermined rotation control method, and sets a target value for the rotational speed or the linear speed of the optical disk.

2. The optical disk device according to claim 1, further comprising:
a constant voltage circuit which generates a voltage of a constant value; and
a selection circuit which switches over to change the input to the spindle motor to either one of the constant voltage circuit, and the rotation control means,
wherein the rotation control means:
when the optical disk has been mounted to the optical disk device, commands the selection circuit to connect the constant voltage circuit to the input to the spindle motor; and
after the CAPA signal generation means has generated the CAPA signal, commands the selection circuit to connect the rotation control means to the input to the spindle motor.

3. The optical disk device according to claim 1,
wherein the predetermined rotation control method is the PCAV method, the ZCLV method, the ZCAV method, the CLV method, or the CAV method.

4. The optical disk device according to claim 1,
wherein the optical disk is a DVD-RAM.
